(19) United States
(12) Patent Application Publication
(10) Pub. No.: US 2021/0245131 A1
(43) Pub. Date: Aug. 12, 2021

(54) DEVICE FOR CHLORINATING TITANIUM-CONTAINING MATERIAL IN A SOLUTION OF CHLORIDE SALTS

(71) Applicant: UST-KAMENOGORSK TITANIUM AND MAGNESIUM PLANT JOINT STOCK COMPANY UKTMP JSC, Ust-Kamenogorsk (KZ)

(72) Inventors: Turar Kusmanovich SARSEMBEKOV, Ust-Kamenogorsk (KZ); Vyacheslav Yurievich CHUVASHOV, Ust-Kamenogorsk (KZ)

(21) Appl. No.: 17/259,293

(22) PCT Filed: Nov. 7, 2018
(86) PCT No.: PCT/KZ2018/000014

§ 371 Date: Jan. 11, 2021

(30) Foreign Application Priority Data
Jul. 11, 2018 (KZ) 2018/0490.1

(51) Int. Cl. B01J 10/00; C01G 23/02; C22B 1/08; C22B 34/12; F27B 1/10

(52) U.S. Cl. CPC B01J 10/005; C01G 23/02; F27B 1/10; C22B 34/12; C22B 1/08

(57) ABSTRACT

The invention relates to non-ferrous metallurgy and concerns a device for chlorinating titanium-containing material in a solution of chloride salts. The technical effect of the invention is an increase in the service life of the device and a reduction in raw material losses. This technical effect is achieved by means of the proposed device for chlorinating titanium-containing material in a solution of chloride salts, comprising a housing, a lined upper cylindrical chamber for a gas-vapour mixture, a lined chlorinating chamber in the shape of an inverted truncated cone, the generatrix of which is inclined at an angle of 15-25° to the axis of the chamber, graphite electrodes, a hearth, tuyeres, chlorine feed lines, and a feedstock charging assembly, wherein the housing is provided with reinforcing ribs in the region of the chlorinating chamber and of an upper drainage pocket.

### FIELD OF INVENTION

The invention relates to non-ferrous metallurgy and concerns a device for chlorinating a titanium-containing raw material in a chloride-salt melt.

### BACKGROUND

RU 2165567 discloses a device for chlorinating a titanium-containing raw material in a metal-chloride melt, which includes a lined shaft divided into a chlorination chamber and a gas-vapor mixture chamber, a device for loading a titanium-containing charge and draining the melt, tuyeres for supplying chloride, and electrodes for heating the melt which are arranged in the chlorination chamber. The chlorination chamber is configured as a truncated cone with its smaller base facing down the chamber, the gas-vapor mixture chamber has a cylindrical shape of constant diameter along the entire height, and the tuyeres are arranged radially in the chlorination chamber. The ratio of the diameter of a lower shaft part to the diameter of an upper shaft part is 1:(1.02-1.05), the ratio of the height of the chlorination chamber to the height of the gas-vapor mixture chamber is 1:(2.2-2,3), nozzles for draining the melt and nozzles for the electrodes and the tuyeres are sealed, the tuyeres are arranged at an angle of 45°-55° to a horizontal axis. The ratio of the height of the chlorination chamber to the total height of the shaft is 1:(3.2-3.3).

The drawbacks of the device design disclosed in RU 2165567 consist in the rapid destruction of the lining of an upper chlorinator drainage assembly which is made of fireclay bricks, the burnout of a housing, a melt leakage, the rapid wear of the housing and the tuyeres due to poor heat exchange and the lack of cooling.

Another chlorinating device is known, which comprises a housing lined with a refractory, a chlorination chamber with a narrowed bottom part, a hearth, melt draining tapholes, a chloride feed line, tuyeres, a lining of refractory blocks in the narrowed bottom part of the chlorination chamber which have a channel made therein. A tuyere tip is arranged in the channel. The angle at which the axis of the channel and the tip is inclined to the plane of the hearth is 5°-6°. The channel has no more than two refractory blocks arranged along its length. The ratio of the cross section of the tip to the cross section of the chloride feed line is 1:(5-6).

The drawbacks of the above-disclosed device design consist in the rapid destruction of the lining of an upper chlorinator drainage assembly which is made of fireclay bricks, the burnout of the housing and a melt leakage, the rapid wear of the housing and tuyeres due to poor heat exchange and the lack of cooling.

SU 1464490 discloses a device for chlorinating a titanium-containing raw material in a chloride-salt melt, which includes a housing, a lined upper cylindrical gas-vapor mixture chamber and a chlorination chamber, graphite electrodes, a hearth, tuyeres, chloride feed lines, a charge loading assembly. The chlorination chamber is configured as an inverted truncated cone having a generatrix inclined at an angle of 15°-25° to a chamber axis. The ratio between the diameter of the hearth, the diameter of the gas-vapor mixture chamber and the height of the chlorination chamber is 1:(1.2-1.5):(3,5-4,5). The charge loading assembly is arranged directly on the chlorination chamber.

The drawbacks of the device design disclosed in SU 1464490 consist in the rapid destruction of the lining of an upper chlorinator drainage assembly made of fireclay bricks, the burnout of the housing and a melt leakage, the rapid wear of the housing and tuyeres due to poor heat exchange and the lack of cooling.

### SUMMARY

The problem solved by the invention is how to increase the service life of the device and reduce raw material losses.

The technical result is an increase in the service life of the device and a reduction in raw material losses.

The technical result is achieved by the proposed device for chlorinating a titanium-containing raw material in a chloride-salt melt. The device comprises a housing, a lined upper cylindrical gas-vapor mixture chamber, a lined chlorination chamber configured as an inverted truncated cone having generatrix inclined at an angle of 15°-25° to a chamber axis, graphite electrodes, a hearth, tuyeres, chloride feed lines, and a charge loading assembly arranged directly on the chlorination chamber. The ratio between the diameter of the hearth, the diameter of the gas-vapor mixture chamber and the height of the chlorination chamber is 1:(1.2-1.5):(3.5-4.5). The device is characterized in that the housing is provided with reinforcing ribs in the region of the chlorination chamber and of an upper drainage pocket, the upper drainage pocket is lined with a graphite plate, and the tuyeres are provided with a compressed air feeding assembly comprising hoses with a metal double tube.

### BRIEF DESCRIPTION OF THE DRAWINGS

FIG. 1 shows a general view of the proposed device, FIG. 2 shows a sectional view of a housing design, and FIG. 3 shows a tuyere with a compressed air feeding assembly.

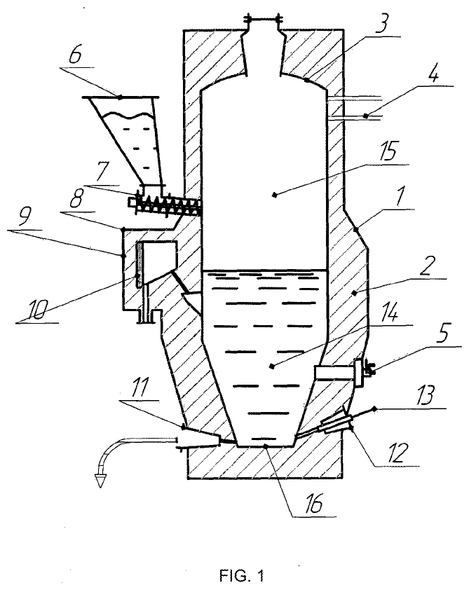

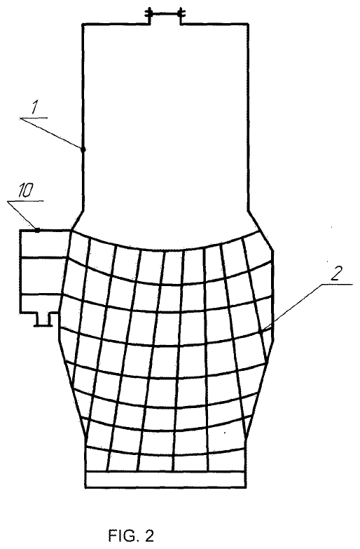

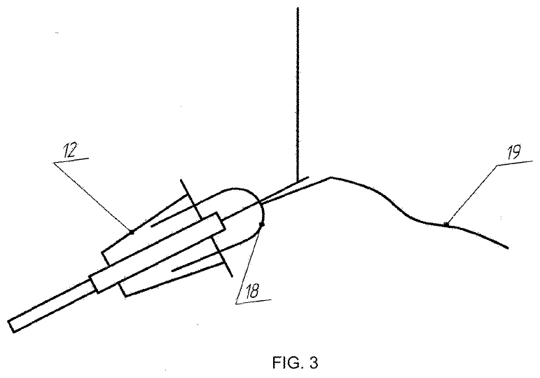

### DETAILED DESCRIPTION OF THE PREFERRED EMBODIMENT

A device for chlorinating a titanium-containing raw material in a chloride-salt melt comprises: a housing 1 having reinforcing ribs 2 welded thereto, the reinforcing ribs increasing a surface area of heat transfer; a lining 3 made of fireclay brick; an arch 4; flues 5; graphite electrodes 6; a charge loading assembly consisting of a hopper 7 with a charge and charge feeders 8; an upper drainage assembly 9 having a pocket 10 lined with a graphite plate 11; a melt drainage taphole 12; tuyeres 13 each having a compressed air feeding assembly provided thereon, the compressed air feeding assembly comprising hoses 14 with a metal double tube 15; chloride feed lines 16; a chlorination chamber 17; a gas-vapor mixture chamber 18; and a hearth 19. The chlorination chamber is configured as an inverted truncated cone having a generatrix of the chlorination chamber 17 inclined at an angle of 15°-25° to a chamber axis.

The device operates as follows. A carnallite melt is poured into the pre-lined chlorination chamber 17 such that the melt covers the graphite electrodes 6 connected to a transformer. After that, a chlorinator begins to warm up to 650° C.-750° C., while sparging with air through the chloride feed lines 16 via the tuyeres 13. During about two days, the melt volume accumulates in the chlorination chamber 17 by loading metals and coke from the hopper 7 through the feeder 8, the lining 3 of the chlorination chamber 17 is impregnated, and residual moisture is removed from the lining. When a predefined temperature (650° C.-750° C.) and an operating level in the chlorination chamber 17 are achieved, gaseous chloride is fed through the chloride feed lines 16 via the tuyeres 13, and a titanium-containing charge is continuously loaded, by the charge feeder 8 from the hopper 7, on the surface of the molten bath in the chlorination chamber 14. A resulting gas-vapor mixture enters the upper gas-vapor mixture chamber 18 under the arch 4 and is removed through the flue 5. The electric heating of the molten bath is optionally carried out using the graphite electrodes 6. Excess heat is removed through the housing along the reinforcing ribs 2 to the environment.

During the chlorination process, the gaseous chloride is supplied through the chloride feed lines 16, and it sparges through the molten bath vertically away from the side walls of the chlorination chamber 17 because the inclination of the generatrix of the chlorination chamber 17 to the chamber axis is 15°-25°. The tuyeres 13 are forcedly cooled by compressed air entering through the hose 14 and the metal double tube 15, which allows reducing their temperature and increasing their service life. Being sparged, the gas forms a foam layer in which the titanium-containing raw material is chlorinated in the center of the volume of the chlorination chamber. The melt moves from the center of the chamber to the side walls towards a calmer zone, where the sparging is less and where the charge is supplied by the feeder 8. In this zone formed by the inclination of the generatrix and the ratio between the diameter of the hearth 19, the diameter of the gas-vapor mixture chamber 18 and the height of the chlorination chamber 17, the melt moistens the charge, thereby reducing its dust carryover, and carries the charge down into the gaseous chloride stream for chlorination. The charge is fully consumed since the loss of chloride through the lining 3 of the chlorination chamber 17 under the housing 1 is sharply reduced.

As its level increases, the melt is periodically drained through the upper drainage assembly 9 whose pocket 10 is lined with the graphite plate 11, thereby preventing the destruction of the brick lining of the pocket and extending the service life of the chlorinator from 18 to 41 months.

What is claimed is:

1. A device for chlorinating a titanium-containing raw material in a chloride-salt melt, comprising a housing, a lined upper cylindrical gas-vapor mixture chamber, a lined chlorination chamber configured as an inverted truncated cone having a generatrix inclined at an angle of 15°-25° to a chamber axis, graphite electrodes, a hearth, tuyeres, chloride feed lines, and a charge loading assembly arranged directly on the chlorination chamber, wherein a ratio between a diameter of the hearth, a diameter of the gas-vapor mixture chamber and a height of the chlorination chamber is 1:(1.2-1.5):(3.5-4.5), and wherein the housing is provided with reinforcing ribs in the region of the chlorination chamber and of an upper drainage pocket, the upper drainage pocket is lined with a graphite plate, and the tuyeres are provided with a compressed air feeding assembly comprising hoses with a metal double tube.
